(19) United States
(12) Patent Application Publication
(10) Pub. No.: US 2015/0140851 A1
(43) Pub. Date: May 21, 2015

(54) SHIELD CONNECTOR STRUCTURE

(71) Applicant: Yazaki Corporation, Tokyo (JP)

(72) Inventor: Feng Wang, Kakegawa-shi (JP)

(21) Appl. No.: 14/603,599

(22) Filed: Jan. 23, 2015

Related U.S. Application Data
(63) Continuation of application No. PCT/JP2013/070141, filed on Jul. 25, 2013.

(30) Foreign Application Priority Data
Jul. 31, 2012 (JP) 2012-169504

(51) Int. Cl. H01R 13/52; H01R 13/6597; H01R 13/6592

(52) U.S. Cl. CPC H01R 13/5221; H01R 13/6592; H01R 13/6597
USPC 439/275

(57) ABSTRACT

A shield connector is provided with: a housing fixed to an outer surface of a metal case; a shield member; a first seal member interposed between the shield member and a shield wire; and a second seal member interposed between the shield member and an insertion hole, the housing having an extension portion extending from a housing body to the insertion hole, the first seal member having a first close contact portion coming into close contact with an outer insulation coating, a second close contact portion coming into close contact with the shield member, and an annular groove portion opened to the outer side of the metal case between the first close contact portion and the second close contact portion, the extension portion of the housing being inserted into the groove portion of the first seal member.

### TECHNICAL FIELD

The invention relates to a shield connector structure, and more particularly, to a shield connection structure for connecting a shield wire, which is inserted into an insertion hole from one side to the other side of a connection object, to the connection object.

### BACKGROUND ART

Conventionally, there has been proposed a shield connector structure for connecting devices, such as a motor, a battery, and an inverter, to one another by a shield wire in a vehicle (in particular, an electric vehicle or a hybrid vehicle) and grounding the shield wire and a case of the devices (e.g., refer to Patent Literature 1). As illustrated in FIG. 7, a shield connector structure 100 described in Patent Literature 1 is intended to connect a shield wire 1 and a metal case 6 of a connection object and to waterproof a connection portion. The shield wire 1 is a coaxial cable including a conductor 2, an inner insulation coating 3 that covers the periphery of the conductor 2, a shield portion 4 that includes a conductor such as a braid and provided around the inner insulation coating 3, and an outer insulation coating 5 that covers the periphery of the shield portion 4. The metal case 6 includes an insertion hole 7 into which the shield wire 1 is inserted, and a bolt hole 8 to which a bolt 106 for fixing a housing 101 is screwed.

The shield connector structure 100 is configured by including the housing 101 in which the shield wire 1 is inserted and which is fixed to the metal case 6, a shield member 102 that electrically connects the shield portion 4 of the shield wire 1 and the metal case 6, a first seal member 103 that is interposed between the inner surface of the shield member 102 and the outer surface of the outer insulation coating 5 of the shield wire 1, a second seal member 104 that is interposed between the outer surface of the shield member 102 and the inner surface of the insertion hole 7 of the metal case 6, a shield pipe 105 that is crimped to cover the shield portion 4 connected to the shield member 102, and the bolt 106 that fixes the housing 101 to the metal case 6.

The housing 101 is fixed to one side (outer side) of the metal case 6 and held with the shield member 102 interposed between the metal case 6 and the housing 101, and is configured to include an insertion portion 111 for inserting the shield wire 1, a cylindrical protrusion portion 112 further extending to the other side (inner side) of the metal case 6 than the insertion portion 111 and inserted into the insertion hole 7, and a flange portion 113 extending radially outward from the insertion portion 111 and fixed to the metal case 6. The shield member 102 is configured to include a first cylindrical portion 121, a second cylindrical portion 122, and a third cylindrical portion 123, of which diameters are increased in three stages from the other side to one side of the metal case 6, and a flange-shaped portion 124 formed along one surface (outer surface) of the metal case 6 bent continuously to the third cylindrical portion 123. The first cylindrical portion 121 is connected to the shield portion 4 of the shield wire 1, and the flange-shaped portion 124 is interposed between one surface of the metal case 6 and the housing 101. The shield portion 4 is grounded through the shield member 102 with respect to the metal case 6.

A first seal member 103 is formed by an elastic material such as a rubber in an entirely cylindrical shape. The first seal member 103 has concavo-convex annular lip portions on an inner peripheral surface thereof and an outer peripheral surface thereof. A plurality of lip portions on the inner peripheral surface is in close contact with the outer surface of the outer insulation coating 5 of the shield wire 1. A plurality of lip portions on the outer peripheral surface is in close contact with each inner surface of the second cylindrical portion 122 of the shield member 102 and the cylindrical protrusion portion 112 of the housing 101. Therefore, a gap between the shield wire 1 and the shield member 102 and the housing 101 is sealed. On the other hand, a second seal member 104 is formed by an elastic material such as a rubber in an entirely cylindrical shape. The second seal member 104 has two articles of lip portions on an inner peripheral surface thereof and an outer peripheral surface thereof. The lip portion on the inner peripheral surface is in close contact with the outer surface of the second cylindrical portion 122 of the shield member 102. The lip portion on the outer peripheral surface is in close contact with the inner surface of the insertion hole 7 of the metal case 6. Therefore, a gap between the shield member 102 and the metal case 6 is sealed.

As described above, in the typical shield connector structure 100 described in Patent Literature 1, the shield wire 1 is mechanically connected to the metal case 6 by the housing 101, and the shield portion 4 is electrically connected to the metal case 6 through the shield member 102. Furthermore, the sealing by the first seal member 103 and the second seal member 104 can achieve the waterproof in the connection portion between the shield wire 1 and the metal case 6, and can prevent water or the like from penetrating from the outside to the inside of the metal case 6.

### CITATION LIST

### Patent Literature

### Patent Literature 1: JP 2000-294344 A

### SUMMARY OF INVENTION

### Technical Problem

However, in the shield connector structure of the related art, the shield wire 1 is inserted into the insertion portion 111 of the housing 101 with some margin. Therefore, in a case where an external force of bending the shield wire 1 is applied, the first seal member 103 pressed to the shield wire 1 is misaligned in a radial direction, which may degrade the water stop performance. Specifically, in FIG. 7, in a case where an external force of bending upward is applied to the shield wire 1 in the outside of the metal case 6, as indicated by a white arrow in the drawing, the upper parts in the drawing among the first seal members 103 are crushed by the shield wire 1, and the seal pressure of the lower parts in the drawing and the cylindrical protrusion portion 112 or the shield member 102 is lowered. The first seal member 103 and the shield member 102 are spaced apart to form a gap. Thus, the water stop performance may be degraded.

The invention has been made in view of the above-described points, and accordingly, it is an object of the invention to provide a shield connector structure capable of improving water stop performance in a connection portion of a shield wire connected by being inserted into an insertion hole of a connection object.

### Solution to Problem

In order to solve the above problems, there is provided a shield connector structure of an aspect of the invention, the shield connector structure for connecting a shield wire to a connection object by inserting the shield wire into an insertion hole of the connection object from one side to the other side, the shield wire including a conductor, an inner insulation coating, a shield portion, and an outer insulation coating, the shield connector structure including: a housing into which the shield wire is inserted and which is fixed to one side of the connection object; a conductive cylindrical shield member that connects the shield portion of the shield wire and the connection object; a first seal member that is interposed between an inner surface of the shield member and an outer surface of the outer insulation coating of the shield wire; and a second seal member that is interposed between an outer surface of the shield member and an inner surface of the insertion hole of the connection object, wherein the housing includes: a housing body that is conducted with the shield member interposed with respect to one surface of the connection object; a fixing portion that is fixed to the connection object; a wire guide portion that inserts the shield wire from one side to the other side through the housing body; and a cylindrical extension portion that extends from the housing body to the inside of the insertion hole of the connection object and is positioned within the shield member, the first seal member includes: a first close contact portion that is formed in a cylindrical shape along the shield wire and comes into close contact with an outer peripheral surface of the outer insulation coating; a second close contact portion that comes into close contact with an inner peripheral surface of the shield member; and an annular groove portion that is opened on one side between the first close contact portion and the second close contact portion.

According to the aspect of the invention, it is preferable that the extension portion of the housing is press-fitted into the groove portion of the first seal member, and the extension portion, the first close contact portion, and the second close contact portion are in close contact with one another.

According to the aspect of the invention or the preferable aspect of the invention, it is further preferable that the shield member includes: a first cylindrical portion that is connected to the shield portion of the shield wire; a second cylindrical portion that is positioned on one side rather than the first cylindrical portion and provided with a large diameter; and a stepped portion that connects the first cylindrical portion and the second cylindrical portion, the second close contact portion of the first seal member is in close contact with an inner peripheral surface of the second cylindrical portion, the second seal member is in close contact with an outer peripheral surface of the second cylindrical portion, and a front end of the first seal member is in close contact with the stepped portion.

According to the aspect of the invention, the preferable aspect of the invention, or the further preferable aspect of the invention, it is further more preferable that a large-diameter portion having an outer diameter larger than an outer diameter of the extension portion is formed at a base end of the extension portion in the housing, and the second close contact portion of the first seal member is positioned at the other side rather than the large-diameter portion.

### Advantageous Effects of Invention

According to the aspect of the invention, by using the first seal member including the first close contact portion, the second close contact portion, the bent portion, and the groove portion, the first close contact portion is brought into close contact with the outer peripheral surface of the outer insulation coating, and the second close contact portion is brought into close contact with the inner peripheral surface of the shield member. The extension portion of the housing is inserted into the groove portion. Eve when the external force of bending the shield wire is applied, it is possible to prevent the misalignment of the first seal member and to suppress the degradation of the water stop performance. That is, since the housing is fixed to the connection object, the extension portion is not moved to a predetermined position of the inside of the insertion hole. The first close contact portion and the second close contact portion are provided with the extension portion being interposed therebetween. Therefore, even when the first close contact portion is pressed by the bending of the shield wire, the second close contact portion is not affected by the deformation. Thus, it is possible to prevent the degradation of the seal pressure of the second close contact portion and the seal member. Therefore, it is possible to prevent water or the like from penetrating from one side (outer side) of the connection object to the other side (inner side) along the shield wire or the shield member. It is possible to improve the water stop performance with respect to the connection portion of the shield portion of the shield wire and the shield member.

According to the preferable aspect of the invention, the extension portion of the housing is press-fitted into the first seal member, and the extension portion, the first close contact portion, and the second close contact portion come into close contact with one another. It is possible to increase the integrity of the housing and the first seal member and to improve the water stop performance by the first seal member. That is, it is possible to secure the close contact state of the first close contact portion of the first seal member and the outer peripheral surface of the outer insulation coating and the close contact state of the second close contact portion and the inner peripheral surface of the shield member. The water stop performance can be further improved. Also, water or the like penetrating between the shield wire and the wire guide portion of the housing is blocked by the close contact part between the extension portion and the first close contact portion. Water or the like penetrating between the housing body and the shield member is blocked by the close contact part between the extension portion and the second close contact portion. Therefore, it is possible to prevent the degradation of the water stop performance by the wraparound of water or the like.

According to the further preferable aspect of the invention, by using the shield member including the first cylindrical portion, the second cylindrical portion, and the stepped portion, the second close contact portion of the first seal member is brought into close contact with the inner peripheral surface of the second cylindrical portion, and the second seal member is brought into close contact with the outer peripheral surface of the second cylindrical portion. The second cylindrical portion of the shield member is interposed between the second close contact portion of the first seal member and the second seal member. Therefore, the close contact states of the respective portions can be satisfactorily maintained. Furthermore, since the front end of the first seal member comes into contact with the stepped portion of the seal member, the water stop performance between the housing and the first seal member can be further improved, and the wraparound of water or the like.

According to the further more preferable aspect of the invention, the large-diameter portion is provided at the base end of the extension portion in the housing, and the second close contact portion of the first seal member is positioned on the other side rather than the large-diameter portion. The second close contact portion and the shield member can be accommodated on the radially outer side of the extension portion. It is possible to form a space for closely contacting these. Therefore, when the first seal member, the housing, and the shield member are attached to the shield wire, the close contact state of the second close contact portion of the first seal member and the shield member can be appropriately maintained, and the excellent water stop performance can be secured after the assembly with the connection object.

### BRIEF DESCRIPTION OF DRAWINGS

FIG. 1 illustrates a cross-sectional view of a shield connector structure according to an embodiment of the invention.

FIG. 2 illustrates a perspective view of a shield wire in the shield connector structure.

FIG. 3 illustrates a perspective view when the shield connector structure is viewed from one side of a connection object.

FIG. 4 illustrates a cross-sectional view of a first seal member in the shield connector structure.

FIG. 5 illustrates a perspective view of the first seal member.

FIG. 6 illustrates a partial exploded cross-sectional view of the shield connector structure.

FIG. 7 illustrates a cross-sectional view of a shield connector structure according to the related art.

### DESCRIPTION OF EMBODIMENTS

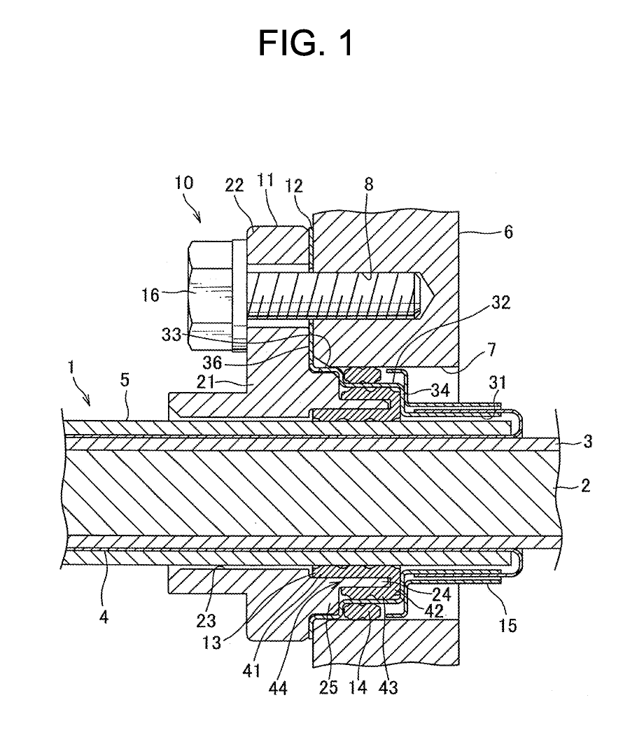

Hereinafter, a shield connector structure according to an embodiment of the invention will be described with reference to FIGS. 1 to 6. The shield connector structure according to the present embodiment is a connection structure suitable to ground a shield wire 1 and achieve waterproof of the connection portion in a case where the shield wire 1 couples a motor and an inverter or couples an inverter and a battery in a vehicle, in particular, an electric vehicle traveling by a driving force of an electric motor, or a hybrid vehicle traveling by a driving force of both an engine and an electric motor.

As illustrated in FIG. 1, the shield wire 1 is a coaxial cable that includes a conductor 2 including a twisted wire or the like provided by twisting a plurality of strands, an inner insulation coating 3 including an insulating synthetic resin to cover the periphery of the conductor 2, a shield portion 4 including a conductor such as a braid and provided around the inner insulation coating 3, and an outer insulation coating 5 including an insulating synthetic resin to cover the periphery of the shield portion 4. On the other hand, a motor, an inverter, or a battery as a connection object has a metal case 6 that constitutes an outer shell thereof. The metal case 6 is provided with an insertion hole 7 into which the shield wire 1 is inserted.

The shield wire 1 is inserted from the outer side (one side) to the inner side (the other side) of the metal case 6 through the insertion hole 7, and a terminal metal fitting 9 is fixed to the conductor 2 at the tip of the inner side. The terminal metal fitting 9 is connected to an electrical connection portion (not illustrated) of the metal case 6. Also, the shield portion 4 of the shield wire 1 is exposed by removing the outer insulation coating 5 from the tip thereof and is grounded to the metal case 6 through a shield member 12 to be described below. The shield portion 4 and the shield member 12 can shield an electromagnetic wave and can prevent a noise from leaking or penetrating from the connection portion.

The shield connector 10 includes the housing 11 into which the shield wire 1 is inserted and which is fixed to the outer surface of the metal case 6, a conductive cylindrical seal member 12 that connects the shield portion 4 of the shield wire 1 and the metal case 6, a first seal member 13 that is interposed between the inner surface of the shield member 12 and the outer surface of the outer insulation coating 5 of the shield wire 1, a second seal member 14 that is interposed between the outer surface of the shield member 12 and the inner surface of the insertion hole 7 of the metal case 6, an annular shield pipe 15 that fixes the shield portion 4 of the shield wire 1 and the shield member 12 by crimping, and a bolt 16 that fixes the housing 11 to the metal case 6.

The housing 11 is a die-cast part that is integrally made of a metal such as an aluminum alloy. The housing 11 is configured to include a housing body 21 that is conducted with the shield member 12 interposed with respect to the outer surface of the metal case 6, a fixing portion 22 that is fixed to the metal case 6 from the outside of the metal case 6, a wire guide portion 23 that inserts the shield wire 1 through the housing body 21, a cylindrical extension portion 24 that extends from the housing body 21 to the inside of the insertion hole 7 of the metal case 6 and is positioned within the shield member 12, and a large-diameter portion 25 that has an outer diameter larger than an outer diameter of the extension portion 24 at the base end of the extension portion 24 and is inserted into the insertion hole 7. The housing 11 is not limited to the metal material, but may be made of a resin as long as it can hold the shield member 12 or the seal member 13.

The shield member 12 includes a conductive metal material and is formed to have a stepped shape such that a diameter is increased in three stages from the inner side toward the outer side of the metal case 6. Specifically, as illustrated in FIG. 6, the shield member 12 is configured to include a first cylindrical portion 31 that is connected to the shield portion 4 of the shield wire 1, a second cylindrical portion 32 that is positioned at the side of the housing 11 rather than the first cylindrical portion 31 (outer side of the metal case 6 being one side) and provided with a large diameter, a third cylindrical portion 33 that is positioned at one side more than the second cylindrical portion 32 and provided with a larger diameter, a first stepped portion 34 that couples the first cylindrical portion 31 and the second cylindrical portion 32, a second stepped portion 35 that couples the second cylindrical portion 32 and the third cylindrical portion 33, and a flange-shaped portion 36 that is formed along the outer surface of the metal case 6 bent continuously to the third cylindrical portion 33.

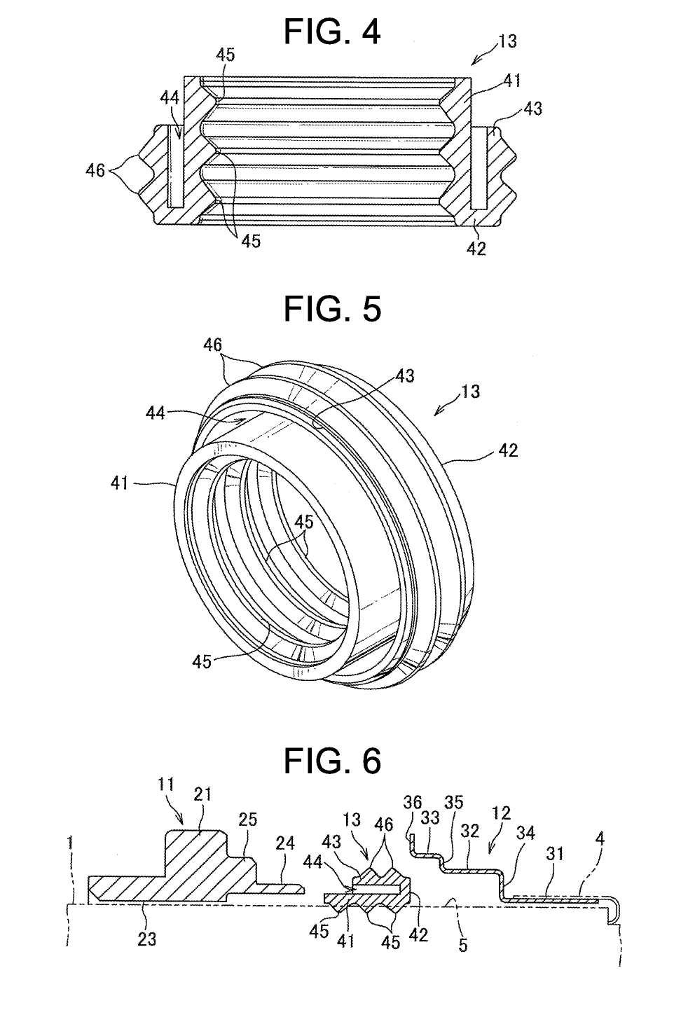

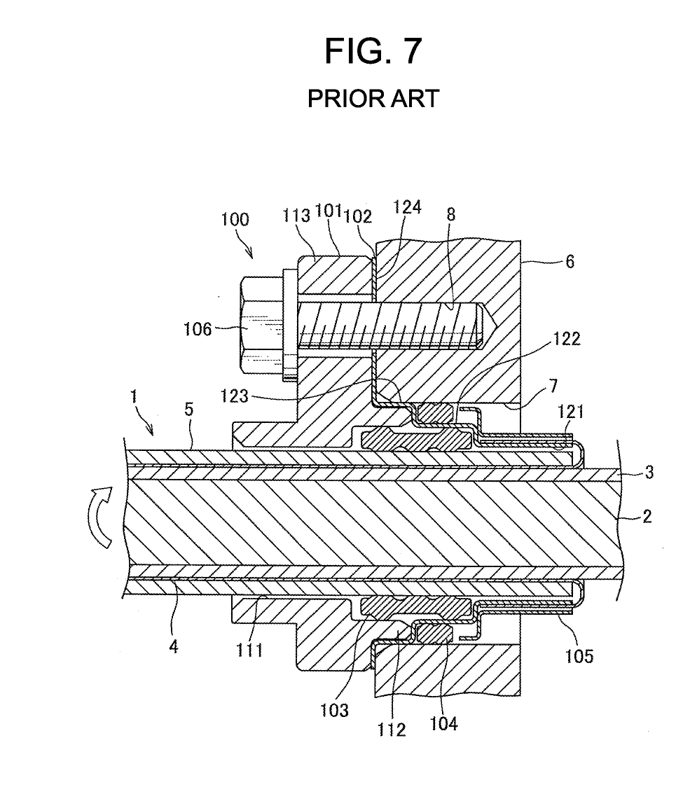

As illustrated in FIGS. 4 to 6, the first seal member 13 includes an elastic material such as a rubber in an entirely cylindrical shape. The first seal member 13 is configured to include a first close contact portion 41 that comes into close contact with the outer peripheral surface of the outer insulation coating 5 along the shield wire 1, a bent portion 42 as a front end bent radially outward continuously to the edge of the other side (inner side of the metal case 6) of the first close contact portion 41, a second cylindrical close contact portion 43 that extends at one side (outer side of the metal case 6) continuously to the radially outer edge of the bent portion 42 and comes into close contact with an inner peripheral surface of the shield member 12, and an annular groove portion 44 that is opened on the housing 11 side between the first close contact portion 41 and the second close contact portion 43. The second close contact portion 43 is formed to be shorter than the first close contact portion 41 and is positioned on the other side (inner side of the metal case 6) rather than the large-diameter portion 25 of the housing 11.

Three articles of annular lips 45 are formed in the inner peripheral surface of the first close contact portion 41 in the first seal member 13. These annular lips 45 are crushed and pressed against the outer peripheral surface of the outer insulation coating 5 and are sealed between the annular lips and the shield wire 1. Also, two articles of annular lips 46 are formed in the outer peripheral surface of the second close contact portion 43. These annular lips 46 are crushed and pressed against the inner peripheral surface of the second cylindrical portion 32 and are sealed between the annular lips and the shield member 12. Furthermore, the outer surface of the bent portion 42 is pressed against the inner surface of the first stepped portion 34, and the gap with the shield member 12 is further sealed. Also, the extension portion 24 of the housing 11 is press-fitted into the groove portion 44 of the first seal member 13, so that the extension portion 24, the first close contact portion 41, and the second close contact portion 43 are in close contact with one another. Therefore, the housing 11 and the first seal member 13 are mutually sealed.

The second seal member 14 includes an elastic material such as a rubber in an entirely cylindrical shape. Two articles of annular lips are formed in the inner peripheral surface and the outer peripheral surface of the second seal member 14. The annular lip of the inner peripheral surface is crushed and pressed against the outer peripheral surface of the second cylindrical portion 32. A gap between the second seal member 14 and the shield member 12 is sealed. The annular lip of the outer peripheral surface is crushed and pressed against the inner peripheral surface of the insertion hole 7. A gap with the metal case 6 is sealed.

As described above, in the inside of the insertion hole 7, in order from the outer peripheral surface of the outer insulation coating 5 toward the inner peripheral surface of the insertion hole 7, the first close contact portion 41 of the first seal member 13, the extension portion 24 of the housing 11, the second close contact portion 43 of the first seal member 13, the second cylindrical portion 32 of the shield member 12, and the second seal member 14 are concentrically positioned and portions adjacent in the radial direction come into close contact with each other. The shield wire 1 is connected to the metal case 6 in a water stop state.

Next, an example of a procedure of assembling the shield wire 1 to the metal case 6 will be described. The procedure of assembling the shield wire 1 is not limited to that described below. After the assembling, the shield connector 10 illustrated in FIG. 1 may be configured, and thus, the following each procedure may be appropriately changed.

First, the shield portion 4 is exposed by peeling the outer insulation coating 5 at the tip of the shield wire 1 cut to a predetermined length, and the tip is inserted into the housing 11, the first seal member 13, and the shield member 12 in this order. Then, the first seal member 13 is moved toward the tip of the shield wire 1, so that the first seal member 13 is press-fitted from the bent portion 42 side into a gap between the outer insulation coating 5 and the second cylindrical portion 32. Therefore, the first close contact portion 41 of the first seal member 13 is brought into close contact with the outer insulation coating 5 of the shield wire 1, so that the bent portion 42 comes into close contact with the inner surface of the first stepped portion 34 of the shield member 12 and the second close contact portion 43 comes into close contact with the inner surface of the second cylindrical portion 32.

The housing 11 is moved toward the tip of the shield wire 1. The extension portion 24 is press-fitted into the groove portion 44 of the first seal member 13. The large-diameter portion 25 of the housing 11 is inserted into the inner side of the third cylindrical portion 33 of the shield member 12. Therefore, the extension portion 24, the first close contact portion 41, and the second close contact portion 43 come into close contact with one another. The housing body 21 and the fixing portion 22 of the housing 11 abut against the flange-shaped portion 36 of the shield member 12. Then, the second seal member 14 is fitted from the tip of the shield wire 1 to the outer periphery of the second cylindrical portion 32 of the shield member 12. Then, as illustrated in FIG. 6, the shield portion 4 of the shield wire 1 is folded to overlap the outer periphery of the first cylindrical portion 31 of the shield member 12. The shield pipe 15 overlapping the outer side of the shield portion 4 is crimped so that the shield member 12 is fixed to the tip of the shield wire 1. Furthermore, the terminal metal fitting 9 is pressed against the conductor 2 exposed by peeling the inner insulation coating 3.

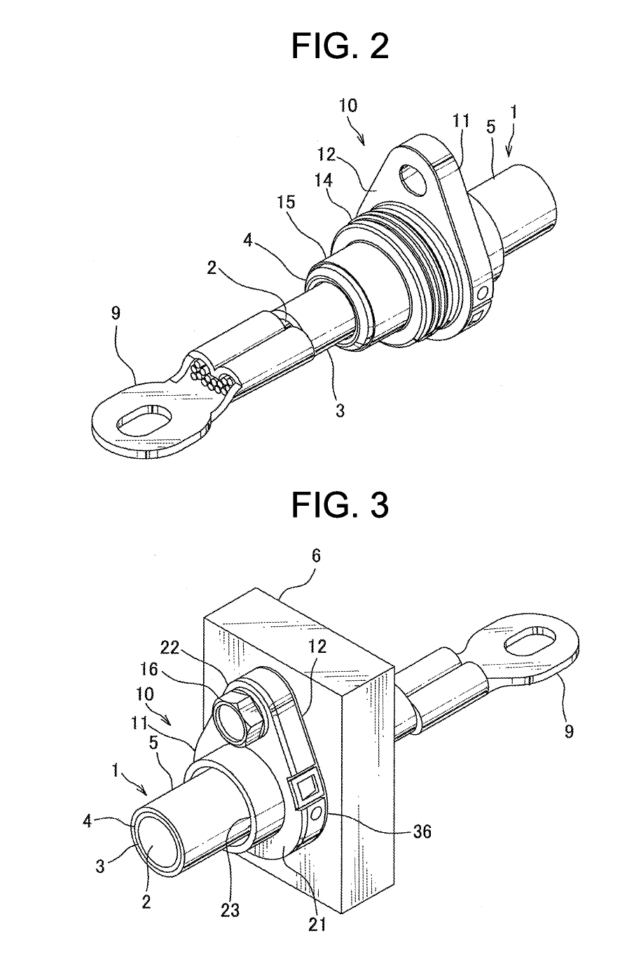

Therefore, as illustrated in FIG. 2, the housing 11, the shield member 12, the first seal member 13, the second seal member 14, and the shield pipe 15 are attached to the tip of the shield wire 1. In this state, the shield wire 1 is inserted from the side of the terminal metal fitting 9 to the insertion hole 7 of the metal case 6. The shield wire 1 is pressed while the second seal member 14 comes into slidable contact with the inner peripheral surface of the insertion hole 7. The third cylindrical portion 33 of the shield member 12 and the large-diameter portion 25 of the housing 11 are inserted into the insertion hole 7. The flange-shaped portion 36 of the shield member 12 abuts against the outer surface of the metal case 6. Then, the bolt 16 inserted into the fixing portion 22 of the housing 11 is screwed to the bolt hole 8 of the metal case 6. The flange-shaped portion 36 is interposed with respect to the outer surface of the metal case 6 by the housing body 21 and the fixing portion 22. Therefore, the shield member 12 is connected to the metal case 6. In this manner, the assembly of the shield wire 1 is completed.

As described above, according to the present embodiment, since the housing 11 is fixed to the metal case 6 and the extension portion 24 of the housing 11 is press-fitted into the groove portion 44 of the first seal member 13, it is possible to prevent misalignment of the first close contact portion 41 and the second close contact portion 43 provided with the extension portion 24 being interposed therebetween. Therefore, even when a force of bending the shield wire 1 is applied and the first close contact portion 41 is pressed, the second close contact portion 43 is not misaligned by the deformation and it is possible to satisfactorily maintain the close contact state of the second close contact portion 43 and the second cylindrical portion 32 of the shield member 12. Also, since the bent portion 42 of the first seal member 13 and the first stepped portion 34 of the shield member 12 are in close contact with each other, the area of the seal portion can be increased. Therefore, the first seal member 13 can reliably prevent water or the like from penetrating from the outer side of the metal case 6 to the inner side along the shield wire 1 or the shield member 12. It is possible to improve the water stop performance with respect to the ground connection portion of the shield portion 4 of the shield wire 1 and the shield member 12.

In the above embodiments, the coaxial cable has been taken as an example of the shield wire 1, but the invention can also be applied to a shield connector structure in a case where a shield wire having a conductor including a plurality of cores is connected. In this case, the shield member, the first seal member, the second seal member, the extension portion of the housing, and the like may be formed to have an oval cross-section or an oval cylindrical cross-section. Also, the connection object is not limited to the motor, the inverter, or the battery used in the electric vehicle or the hybrid vehicle, and may be other appropriate electric devices or an electrical connection box in which electrical components are provided therein. Also, the object to ground the shield wire is not limited to the metal case 6 and may be a portion provided for the ground connection.

### REFERENCE SIGNS LIST

1 shield wire
2 conductor
3 inner insulation coating
4 shield portion
5 outer insulation coating
6 metal case (connection object)
7 insertion hole
10 shield connector
11 housing
12 shield member
13 first seal member
14 second seal member
21 housing body
22 fixing portion
23 wire guide portion
24 extension portion
25 large-diameter portion
31 first cylindrical portion
32 second cylindrical portion
34 first stepped portion (stepped portion)
41 first close contact portion
42 bent portion
43 second close contact portion
44 groove portion

1. A shield connector structure for connecting a shield wire to a connection object by inserting the shield wire into an insertion hole of the connection object from one side to the other side, the shield wire including a conductor, an inner insulation coating, a shield portion, and an outer insulation coating, the shield connector structure comprising:
a housing into which the shield wire is inserted and which is fixed to one side of the connection object;
a conductive cylindrical shield member that connects the shield portion of the shield wire and the connection object;
a first seal member that is interposed between an inner surface of the shield member and an outer surface of the outer insulation coating of the shield wire; and
a second seal member that is interposed between an outer surface of the shield member and an inner surface of the insertion hole of the connection object, wherein
the housing includes:
a housing body that is conducted with the shield member interposed with respect to one surface of the connection object;
a fixing portion that is fixed to the connection object;
a wire guide portion that inserts the shield wire from one side to the other side through the housing body; and
a cylindrical extension portion that extends from the housing body to the inside of the insertion hole of the connection object and is positioned within the shield member,
the first seal member includes:
a first close contact portion that is formed in a cylindrical shape along the shield wire and comes into close contact with an outer peripheral surface of the outer insulation coating;
a second close contact portion that comes into close contact with an inner peripheral surface of the shield member; and
an annular groove portion that is opened on one side between the first close contact portion and the second close contact portion, wherein
the extension portion of the housing is inserted into the groove portion of the first seal member.

2. The shield connector structure according to claim 1, wherein the extension portion of the housing is press-fitted into the groove portion of the first seal member, and the extension portion, the first close contact portion, and the second close contact portion are in close contact with one another.

3. The shield connector structure according to claim 1, wherein the shield member includes:
a first cylindrical portion that is connected to the shield portion of the shield wire;
a second cylindrical portion that is positioned on one side rather than the first cylindrical portion and provided with a large diameter; and
a stepped portion that couples the first cylindrical portion and the second cylindrical portion,
the second close contact portion of the first seal member is in close contact with an inner peripheral surface of the second cylindrical portion,
the second seal member is in close contact with an outer peripheral surface of the second cylindrical portion, and
a front end of the first seal member is in close contact with the stepped portion.

4. The shield connector structure according to claim 2, wherein the shield member includes:
a first cylindrical portion that is connected to the shield portion of the shield wire;
a second cylindrical portion that is positioned on one side rather than the first cylindrical portion and provided with a large diameter; and
a stepped portion that couples the first cylindrical portion and the second cylindrical portion,
the second close contact portion of the first seal member is in close contact with an inner peripheral surface of the second cylindrical portion,
the second seal member is in close contact with an outer peripheral surface of the second cylindrical portion, and
a front end of the first seal member is in close contact with the stepped portion.

5. The shield connector structure according to claim 1, wherein a large-diameter portion having an outer diameter larger than an outer diameter of the extension portion is formed at a base end of the extension portion in the housing, and the second close contact portion of the first seal member is positioned at the other side rather than the large-diameter portion.

6. The shield connector structure according to claim 2, wherein a large-diameter portion having an outer diameter larger than an outer diameter of the extension portion is formed at a base end of the extension portion in the housing, and the second close contact portion of the first seal member is positioned at the other side rather than the large-diameter portion.

7. The shield connector structure according to claim 3, wherein a large-diameter portion having an outer diameter larger than an outer diameter of the extension portion is formed at a base end of the extension portion in the housing, and the second close contact portion of the first seal member is positioned at the other side rather than the large-diameter portion.

8. The shield connector structure according to claim 4, wherein a large-diameter portion having an outer diameter larger than an outer diameter of the extension portion is formed at a base end of the extension portion in the housing, and the second close contact portion of the first seal member is positioned at the other side rather than the large-diameter portion.
